(19) United States
(12) Patent Application Publication
(10) Pub. No.: US 2021/0225598 A1
(43) Pub. Date: Jul. 22, 2021

(54) MUTED KEY MODULE, ELECTRONIC DEVICE AND IMPLEMENTATION METHOD

(71) Applicant: SHENZHEN HUI CHUANG DA TECHNOLOGY CO., LTD., SHENZHEN (CN)

(72) Inventors: MING LI, SHENZHEN (CN); CHUANCHUN CAO, SHENZHEN (CN); NIAN HU, XIANTAO (CN); JlNXlN DING, SHENZHEN (CN); QIDONG LI, QINGDAO (CN)

(21) Appl. No.: 17/055,609

(22) PCT Filed: Aug. 7, 2018
(86) PCT No.: PCT/CN2018/099234

§ 371 Date: Nov. 16, 2020

(30) Foreign Application Priority Data
Jul. 31, 2018 (CN) 201821222804,6

(51) Int. Cl. H01H 3/12; H01H 3/60

(52) U.S. Cl. CPC H01H 3/12; H01H 2221/062; H01H 3/60

(57) ABSTRACT

The present invention discloses a muted key module, an electronic device and an implementation method. The key module includes a switch member, a triggering mechanism and a supporting member, wherein the triggering mechanism is arranged corresponding to the switch member. The triggering mechanism can be moved along the contacting and separating directions of the switch member, thus to realize an ON or OFF operation of the switch member. A muting layer is arranged between the switch member and the supporting member. In the present invention, the muting layer is arranged between the switch member and the supporting member, so the impact force the between the triggering mechanism and the switch member can be cushioned by the muting layer, thereby reducing the noise produced when the key is pressed, thus to improve the quality of the final product as a whole.

### TECHNICAL FIELD

The present invention discloses a key module, and more particularly to a muted key module, an electronic device and an implementation method.

### BACKGROUND

Dome, whose full name is metal dome or dome array or dome sheet, has long been used abbreviatedly, so it is called Dome or dome sheet. A Dome is a piece of PET sheet containing an elastic metal sheet (metal dome), which is used on PCB, FPC or other circuit boards as a switch which plays an important tactile switch between a user and a device. Compared with traditional silica gel keys, a membrane key has a better touch feeling, a longer life, and can indirectly improve the production efficiency of various types of the switches that use conductive films.

The metal dome (namely Dome) in the membrane key is located on a conductive portion of the PCB (mostly located above the golden fingers on the circuit board). Once pressed, a center point of the metal dome dents to touch the circuit on the PCB, thus a loop is formed, a current passes through the loop so that the entire device can work normally. The Dome is an important part of the switch, with the help of the conductivity of the metal dome, it serves as a high-quality switch between the user and the device. At the same time, the stable resilience (automatically return back after being pressed down) and long life of the dome sheet can also provide the users with high quality tactile feedback.

Membrane keys adopting the Dome are widely used in various electronic products, such as mobile phone side keys, laptop touch panels, headsets wire control, and etc. Due to the limitation of their specific structure, the membrane keys adopting the Dome will bring a noticeable dull feeling during both their pressing and rebounding processes, that is, tactile feedback, or key travel. Besides, the membrane keys adopting the Dome will produce an obvious sound during the pressing process, that is, once pressed, they will sound “clicking”, “clicking”, “clicking”. The above-mentioned membrane keys will lower the products level in the case that they are applied in high-end electronic products. Therefore, how to reduce the key noise of the membrane keys is an urgent problem to be solved in the industry.

### SUMMARY

In view of the above-mentioned deficiency that the membrane keys adopting the Dome in the prior art will produce a strong key noise when the key is pressed, the present invention provides a muted key module, an electronic device and an implementation method. A muting layer is arranged between a switch member and a supporting member, which is used to cushion an impact force between a triggering mechanism and the switch member, thereby reducing the noise produced when the key is pressed, and thus to improve the quality of the final product as a whole.

The technical solution provided in the present invention to solve the technical problem is to provide a muted key module which includes a switch member, a triggering mechanism and a supporting member, wherein the trigger mechanism is arranged corresponding to the switch member, the triggering mechanism can be moved along the contacting and separating directions of the switch member to realize an ON or OFF operation of the switch member; a muting layer is arranged between the switch member and the supporting member.

An electronic device, wherein the above-mentioned muted key module is used as a key module in the electronic device.

An implementation method for muting noise in a key module, wherein the method includes setting a muting layer between the switch member and the supporting member in the key module, so that an impact force between the triggering mechanism and the switch member can be cushioned by the muting layer, thereby reducing the noise produced when the key is pressed.

The technical solutions adopted by the present invention to solve the technical problems further include:

A fixing film is firmly arranged above the triggering mechanism, the triggering mechanism is firmly arranged on the fixing film.

A bump is firmly arranged on the fixing film and is arranged corresponding to the triggering mechanism.

A spacer is arranged under the fixing film and is arranged corresponding to the triggering mechanism. The spacer is provided with a through hole at a position corresponding to the triggering mechanism, and the triggering mechanism is embedded into the through hole.

More than one air guiding grooves is provided on the periphery of the through hole.

A PCB is used as the supporting member, the switch member includes a first conductive electrode and a second conductive electrode. An insulating portion is arranged between the first conductive electrode and the second conductive electrode, so that the first conductive electrode and the second conductive electrode are isolated from each other. The first conductive electrode and the second conductive electrode are firmly arranged on an FPC respectively, the circuit on the FPC and the circuit on the PCB are configured as being conductive to each other, and the muting layer is arranged between the FPC and the PCB.

A supporting plate is used as the supporting member, the switch member includes a first conductive electrode and a second conductive electrode. The first conductive electrode and the second conductive electrode are respectively arranged on an FPC, and the FPC is provided with a conductive circuit. An insulating portion is arranged between the first conductive electrode and the second conductive electrode, so that the first conductive electrode and the second conductive electrode are isolated from each other. The FPC is arranged above the supporting plate, and a muting layer is arranged between the FPC and the supporting member.

A PCB board is used as the supporting member. The switch member includes a first conductive electrode and a second conductive electrode. An insulating portion is arranged between the first conductive electrode and the second conductive electrode, so that the first conductive electrode and the second conductive electrode are insulated from each other. The muting layer is made of flexible conductive material. The first conductive electrode and the second conductive electrode are pasted on the PCB board through the flexible conductive material.

The beneficial effect of the present invention is that: the muting layer is arranged between the switch member and the supporting member in the present invention, so that the impact force between the triggering mechanism and the switch member can be cushioned, thereby reducing the noise produced when the key is pressed, and thus to improve the quality of the final product as a whole.

### BRIEF DESCRIPTION OF THE DRAWINGS

The present invention is further described in combination with the drawings and specific embodiments.

FIG. 1 is an exploded structural view according to the present invention.

FIG. 2 is a cross-sectional structural view according to Embodiment 1 of the present invention.

FIG. 3 is a cross-sectional structural view according to Embodiment 2 of the present invention.

FIG. 4 is a cross-sectional structural view according to Embodiment 3 of the present invention.

Supporting member 1, switch member 2, triggering mechanism 3, muting layer 4, fixing film 5, bump 6, spacer 7, through hole 8, air guiding groove 9, PCB 10, first conductive electrode 11, second conductive electrode 12, insulating portion 13, FPC 14, supporting plate 15, conductive layer 16.

### DETAILED DESCRIPTION

The embodiments are preferred implementations of the present invention, other embodiments having the same or similar principle and basic structure will fall in the protection scope of the present invention.

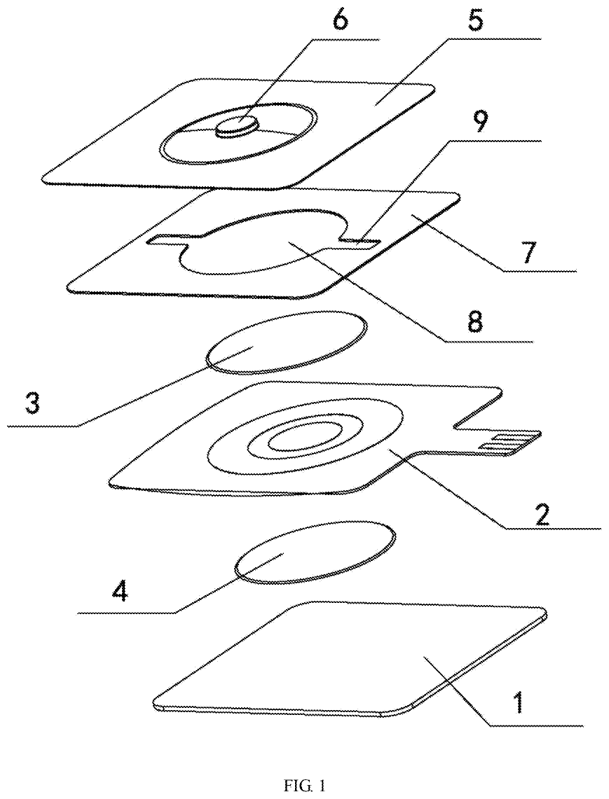

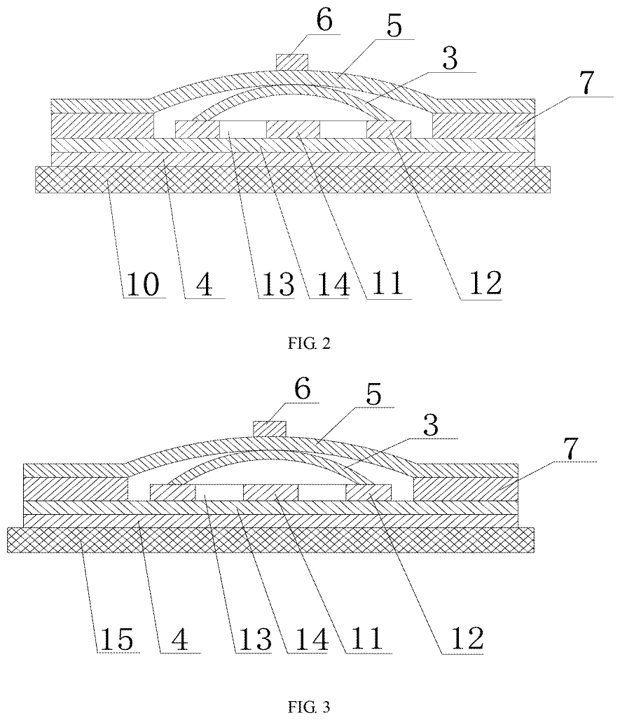

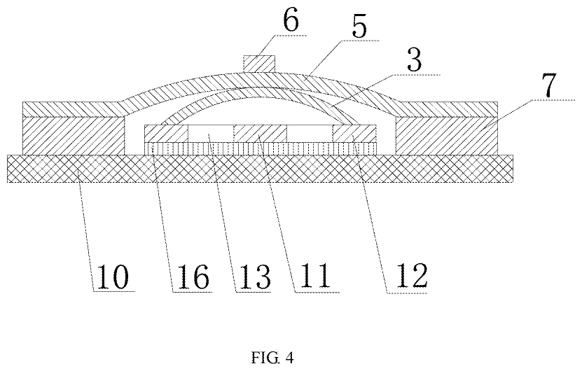

Please refer to FIG. 1, the present invention mainly protects a muted key module which includes a switch member 2, a triggering mechanism 3 and a supporting member 1, wherein the triggering mechanism 3 is arranged corresponding to the switch member 2. The triggering mechanism 3 can be moved along the contacting and separating directions of the switch member 2, so as to realize an ON or OFF operation of the switch member 2. A muting layer 4 is arranged between the switch member 2 and the supporting member 1, thus, on the basis of ensuring that the triggering mechanism 3 can trigger the switch member 2 to be turned on or off, the impact force between the triggering mechanism 3 and the switch member 2 can also be cushioned, thereby reducing the noise produced when the key is pressed.

In the present embodiment, the muting layer 4 is made of a flexible material which is conductive or non-conductive. Specifically, the muting layer 4 may be made of silica gel, rubber, conductive foam, conductive silica gel, etc.

In the present embodiment, an attaching mechanism for fixing the switch member 2 can also be added under the switch member 2, thus to firmly arrange the switch member 2 on the attaching mechanism, therefore the switch member 2 is fixed through the attaching mechanism. The muting layer 4 can be arranged between the attaching mechanism and the supporting member 1.

In the present embodiment, a fixing film 5 is fixed above the triggering mechanism 3. The triggering mechanism 3 is firmly arranged on the fixing film 5, thus the triggering mechanism 3 is fixed through the fixing film 5. A bump 6 (also known as Plunger) is firmly arranged on the fixing film 5 and is arranged corresponding to the triggering mechanism 3, so that a triggering feeling of the triggering mechanism 3 can be enhanced through the bump 6. In the present embodiment, the bump 6 can be arranged above or below the fixing film 5. The bump 6 can be attached by pasting or UV glue.

In the present embodiment, a spacer 7 is arranged under the fixing film 5 and is arranged corresponding to the triggering mechanism 3. The spacer 7 is provided with a through hole 8 at a position corresponding to the triggering mechanism 3, the triggering mechanism 3 is embedded into the through hole 8. In the present embodiment, more than one air guiding grooves 9 is provided on the periphery of the through hole 8 for discharging the air under the triggering mechanism 3 when it is triggered, so as to enhance touching feeling during use and to make the pressing more smoothly. In the present embodiment, the triggering mechanism 3 can use a metal dome (also called DOME).

The structure of the present invention will be further described with several specific embodiments hereafter.

Embodiment 1: in this embodiment, a PCB 10 is used as the supporting member 1. The switch member 2 includes a first conductive electrode 11 and a second conductive electrode 12. An insulating portion 13 is provided between the first conductive electrode 11 and the second conductive electrode 12, so that the first conductive electrode 11 and the second conductive electrode 12 are insulated from each other. The first conductive electrode 11 is configured as a disc shape, and the second conductive electrode 12 is configured as an annular-ring shape. In specific implementation, the first conductive electrode 11 and the second conductive electrode 12 can also be configured as a “ [symbol] ” shape, a semicircular shape, a strip shape, etc. The first conductive electrode 11 and the second conductive electrode 12 are firmly arranged on an FPC 14 respectively, and the FPC 14 is used as the attaching mechanism for the switch member 2. The electrode 11 and the second conductive electrode 12 are made of conductive copper sheets, which are processed on the FPC 14 by etching or pasting procedure, etc. The FPC 14 is fixed on the PCB 10 by pasting or welding procedure, etc. The circuit on the FPC 14 and the circuit on the PCB 10 are configured as being conductive to each other. The muting layer 4 is arranged between the FPC 14 and the PCB 10, so that an impact force between the triggering mechanism 3 and the switch member 2 can be cushioned by the muting layer 4, thereby reducing the noise produced when the key is pressed.

In this embodiment, the muting layer 4 can be a spacing sheet made of a flexible material, and it could be several spacing sheets which are provided corresponding to each switch member 2 or one entire spacing sheet which is provided corresponding to all the switch members 2.

Embodiment 2: in this embodiment, a supporting plate 15 or a bottom plate of an electronic device in use is used as the supporting member 1. The switch member 2 includes a first conductive electrode 11 and a second conductive electrode 12, the first conductive electrode 11 and the second conductive electrode 12 are respectively arranged on an FPC 14. An insulating portion 13 is arranged between the first conductive electrode 11 and the second conductive electrode 12 for insulating the first conductive electrode 11 and the second conductive electrode 12 from each other. The first conductive electrode 11 is configured as a disc shape, and the second conductive electrode 12 is configured as an annular ring shape. In specific implementation, the first conductive electrode 11 and the second conductive electrode 12 can also be configured as a “ [symbol] ” shape, a semicircular shape, or a strip shape, etc. The first conductive electrode 11 and the second conductive electrode 12 are firmly arranged on the FPC 14 respectively. The FPC 14 is used as the attaching mechanism for the switch member 2. The first conductive electrode 11 and the second conductive electrode 12 are made of conductive copper sheets, which are processed on the FPC 14 by etching and pasting procedure, etc., and the FPC 14 is arranged above the supporting member 1. The muting layer 4 is arranged between the FPC 14 and the supporting member 1, so that an impact force between the triggering mechanism 3 and the switch member 2 can be cushioned by the muting layer 4, thereby reducing the noise produced when the key is pressed.

In this embodiment, the muting layer 4 can be a spacing sheet made of a flexible material, and it could be several spacing sheets which are provided corresponding to each switch member 2 or one entire spacing sheet which is provided corresponding to all the switch members 2.

Embodiment 3: in this embodiment, a PCB 10 is used as the supporting member 1, and the switch member 2 includes a first conductive electrode 11 and a second conductive electrode 12. An insulating portion 13 is provided between the first conductive electrode 11 and the second conductive electrode 12, so that the first conductive electrode 11 and the second conductive electrode 12 are insulated from each other. The first conductive electrode 11 is configured as a disc shape, and the second conductive electrode 12 is configured as an annular shape. In specific implementation, the first conductive electrode 11 and the second conductive electrode 12 can also be configured as a “ [symbol] ” shape, a semicircle shape, a strip shape, etc. The first conductive electrode 11 and the second conductive electrode 12 are directly pasted on the PCB 10 through a conductive layer 16, such as flexible conductive silica gel or conductive foam. Therefore, an impact force between the triggering mechanism 3 and the switch member 2 can be cushioned by the flexible conductive silica gel or conductive foam, thereby reducing the noise produced when the key is pressed.

The present invention also protects an electronic device. the above-mentioned muted key module is used as a key module in the electronic device. The electronic device could be an electronic device with keys, such as a notebook computer, a Bluetooth keyboard, a mobile phone, a tablet computer, etc.

The present invention also protects an implementation method for muting noise in a key module. The method includes setting a muting layer between a switch member and a supporting member in the key module, so that an impact force between a triggering mechanism and a switch member can be cushioned by the muting layer, thereby reducing the noise produced when the key is pressed, and improving the quality of the final product as a whole.

In the present invention, the muting layer is arranged between the switch member and the supporting member, the impact force between the triggering mechanism and the switch member can be cushioned by the muting layer, thereby reducing the noise produced when the key is pressed, thus to improve the quality of the final product as a whole.

1. A muted key module, comprising a key module which includes a switch member, a triggering mechanism and a supporting member, wherein the triggering mechanism is arranged corresponding to the switch member: the triggering mechanism can be moved along the contacting and separating directions of the switch member for realizing an ON or OFF operation of the switch member; a muting layer is arranged between the switch member and the supporting member.

2. The muted key module according to claim 1, wherein a fixing film is firmly arranged above the triggering mechanism, the triggering mechanism is firmly arranged on the fixing film.

3. The muted key module according to claim 2, wherein a bump is firmly arranged on the fixing film and is arranged corresponding to the triggering mechanism.

4. The muted key module according to claim 2, wherein a spacer is arranged below the fixing film and is arranged corresponding to the triggering mechanism; the spacer is provided with a through hole at a position corresponding to the triggering mechanism, and the triggering mechanism is embedded into the through hole.

5. The muted key module according to claim 4, wherein more than one air guiding grooves is provided on the periphery of the through hole.

6. The muted key module according to claim 1, wherein a PCB is used as the supporting member, the switch member includes a first conductive electrode and a second conductive electrode; an insulating portion is arranged between the first conductive electrode and the second conductive electrode, so that the first conductive electrode and the second conductive electrode are isolated from each other; the first conductive electrode and the second conductive electrode are firmly arranged on an FPC respectively, the circuit on the FPC and the circuit on the PCB are configured as being conductive to each other, and the muting layer is arranged between the FPC and the PCB.

7. The muted key module according to claim 1, wherein a supporting plate is used as the supporting member, the switch member includes a first conductive electrode and a second conductive electrode, the first conductive electrode and the second conductive electrode are respectively arranged on an FPC, and the FPC is provided with a conductive circuit; an insulating portion is arranged between the first conductive electrode and the second conductive electrode, so that the first conductive electrode and the second conductive electrode are isolated from each other; the FPC is arranged above the supporting plate, and a muting layer is arranged between the FPC and the supporting member.

8. The muted key module according to claim 1, wherein a PCB is used as the supporting member, the switch member includes a first conductive electrode and a second conductive electrode; an insulating portion is arranged between the first conductive electrode and the second conductive electrode, so that the first conductive electrode and the second conductive electrode are insulated from each other; the muting layer is made of flexible conductive material, the first conductive electrode and the second conductive electrode are pasted on the PCB board through the flexible conductive material.

9. An electronic device, wherein a muted key module according to claim 1 is used as a key module in the electronic device.

10. An implementation method for muting noise in a key module, wherein the method includes setting a muting layer between a switch member and a supporting member in the key module, an impact force between a triggering mechanism and the switch member can be cushioned by the muting layer, thereby reducing the noise produced when the key is pressed.
